(19) United States
(12) Patent Application Publication
(10) Pub. No.: US 2026/0127681 A1
(43) Pub. Date: May 7, 2026

(54) INSURANCE CLAIM DENIAL MANAGEMENT SYSTEM USING INTEGRATED PROGRAMMATIC AND SPECIALIZED GUIDED AND CONSTRAINED ARTIFICIAL INTELLIGENCE

(71) Applicant: Ocean Friends, Inc., Irving, TX (US)

(72) Inventors: Anusha Tiwari, Chennai (IN); Animesh Kumar, Irving, TX (US)

(73) Assignee: Ocean Friends, Inc., Irving, TX (US)

(21) Appl. No.: 19/380,946

(22) Filed: Nov. 5, 2025

Related U.S. Application Data
(60) Provisional application No. 63/716,725, filed on Nov. 5, 2024.

(51) Int. Cl. G06Q 40/08

(52) U.S. Cl. CPC G06Q 40/084; G06Q 40/09

(57) ABSTRACT

An automatic insurance claim denial management system and process are disclosed. The automatic insurance claim denial management method receives a notification of denial of the insurance claim by one or more payers. The notification also includes an Electronic Remittance Advice (ERA) reconciliation data provided by the payer. One or more reasons for claim denial are automatically identified by analyzing the ERA data. After analysis of the ERA data and knowing one or more reasons for the denial of the insurance claim, corrections are applied to an insurance claim form i.e., rejected by the payer. Finally, the modified insurance claim form is submitted to the payer, ensuring that the insurance claims meet the necessary criteria for approval upon re-submission.

### CROSS-REFERENCE TO RELATED APPLICATION(S)

This application claims the benefit under 35 U.S.C. § 119(e) and 37 C.F.R. § 1.78 of U.S. Provisional Application No. 63/716,725 which is incorporated by reference in its entirety.

### FIELD OF THE INVENTION

The present invention generally relates to the field of electronics, and more specifically to a system of handling or management of denied medical insurance claims from the insurance company due to a plurality of reasons.

### BACKGROUND OF THE INVENTION

In healthcare, managing health insurance claim denials is a critical process because it directly impacts a provider's revenue. A claim denial occurs when an insurance company, government payer, or another third-party payer refuses to pay for medical services that a healthcare provider has already delivered. This rejection can happen for a variety of reasons, including mistakes in medical billing, incorrect or incomplete patient information, coding errors, or services deemed medically unnecessary by the insurance company.

When a claim is denied, it causes a delay in payment, which can disrupt the provider's cash flow. If the denial is not resolved, it can lead to a permanent loss of revenue. For hospitals, diagnostic centers, and clinics that depend on regular income to cover operating costs like staff salaries, medical supplies, and other expenses, claim denials can create significant financial strain. This makes timely denial management essential to maintain the financial health of the organization.

Effective denial management involves identifying the reasons for denials, correcting any errors, resubmitting claims, and ensuring that future claims are submitted accurately to avoid repeat denials. It also requires careful attention to detail in medical coding, which translates the services provided into standardized codes used by insurers to determine payments. Any inaccuracies in this process can lead to claims being denied, making it crucial for healthcare providers to invest in proper training and technology to restructure their billing processes.

### SUMMARY

An automatic insurance claim denial management system and process are disclosed herein which deals with the management of the denied or rejected insurance claims by the payer due to a plurality of reasons. The reason for the insurance claim denial can be identified automatically using the insurance claim denial management system, based on which the modifications can be made automatically.

In an embodiment of the present disclosure, an automatic insurance claim denial management process is disclosed. The automatic insurance claim denial management method receives a notification of a denial (also referred to herein as a rejection) of the insurance claim by one or more payers. The notification also includes an Electronic Remittance Advice (ERA) reconciliation data provided by the payer. The one or more reasons due to which the claims are denied or rejected by the payer are automatically identified by analyzing the ERA data. After the analysis of the ERA data and knowing one or more reasons for the rejection or denial of the insurance claim, a set of corrections are applied to an insurance claim form i.e., rejected by the payer. The set of corrections can be done both manually, as well as automatically. Finally, the modified insurance claim form is submitted to the payer, ensuring that the insurance claims meet the necessary criteria for approval upon re-submission. The modified insurance claim form is known as a secondary insurance claim form.

In addition, an automatic insurance claim denial management system is disclosed. The automatic insurance claim denial management system for managing the denial or rejected insurance claims by the payer includes a computer system with one or more processors and databases, operatively coupled to the processors, to perform specific operations. The automatic insurance claim denial management system receives a notification of rejection or denial of the insurance claim by one or more payers via. a notification module. The notification also includes an Electronic Remittance Advice (ERA) reconciliation data provided by the payer. The notification is displayed to the user on a user interface, which is integrated within an online billing platform. The one or more reasons due to which the claims are denied or rejected by the payer are automatically identified by analyzing the ERA data using an analyzer. After the analysis of the ERA data by the analyzer and knowing one or more reasons for the rejection or denial of the insurance claim, corrections are applied to an insurance claim form i.e., rejected by the payer automatically using an insurance claim modifier. The corrections can be done both manually, as well as automatically. Finally, an uploader submits the modified insurance claim form to the payer, ensuring that the insurance claims meet the necessary criteria for approval upon re-submission. The modified insurance claim form is known as a secondary insurance claim form.

Furthermore, the one or more reasons due to which the one or more payers reject or deny the insurance claims include inappropriate or insufficient information (i.e., inaccurate information), insurance expiration, the amount exceeding the threshold values, non-covered medical sessions, general errors, and incomplete information from users.

Further, the modified claim form acts as a secondary medical insurance claim sent to the payer.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary automatic insurance claim denial management system.

FIG. 2 depicts an exemplary automatic insurance claim denial management process.

FIG. 3 depicts an exemplary user interface disclosing the user profile categorized based on various parameters.

FIGS. 4 and 5 depict exemplary user interfaces disclosing the billing details and other categories which are detected automatically by the automatic insurance claim denial management system to reduce the denial or rejection of the insurance claim.

FIG. 6 depicts an exemplary user interface disclosing the list of denied or rejected insurance claims received from one or more payers.

FIG. 7 depicts an exemplary user interface that discloses the reason for the rejection or denial of the insurance claim from the payer.

FIG. 8 depicts an exemplary user interface that discloses the insurance claim form that is modified by the automatic insurance claim denial management system.

FIGS. 9 and 10 depict exemplary user interfaces that refresh the rejected or denied insurance claim form after modification and submit it to the payer respectively.

FIG. 11 depicts an exemplary network environment in which the system of FIG. 1 and the process of FIG. 2 may be practiced.

FIG. 12 depicts an exemplary computer system.

### DETAILED DESCRIPTION

An automatic insurance claim denial management system includes an online billing platform and a denial handling module. The online billing platform and the denial handling module are operatively coupled to each other. A notification module is integrated within the denial handling module which receives the notification of the denied or rejected insurance claims from the payer. Along with the notification, an Electronic Remittance Advice (ERA) reconciliation data is provided by the payer to the user using the online billing platform. The notifications are made visible to the user on a user interface integrated into the online learning platform. The ERA data is analyzed using an analyzer, integrated within the denial handling module. By analyzing the ERA data, one or more reasons for the denial or rejection of the insurance claims are identified automatically.

The corrections are applied on the rejected or denied insurance claim form based on one or more reasons identified by the analyzer using an insurance claim modifier. The modified insurance claim is further submitted to the payer using an uploader. The uploaded insurance claim form is visible to the user on the user interface and is termed as a secondary insurance claim since the payer is asked for the second time to make the payment.

The automatic insurance claim denial management system offers several significant advantages in managing medical insurance claim denials. The automatic insurance claim denial management system automates the identification of denial or rejection of the insurance claims, reducing the need for manual intervention and thereby minimizing errors in processing claims. By automatically mapping identified reasons to specific denial codes, the automatic insurance claim denial management system ensures accurate and timely identification of issues, leading to faster resolution of denied claims. The automatic correction and automatic resubmission of the insurance claims thereby enhance the efficiency and reduce the time for the payment.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

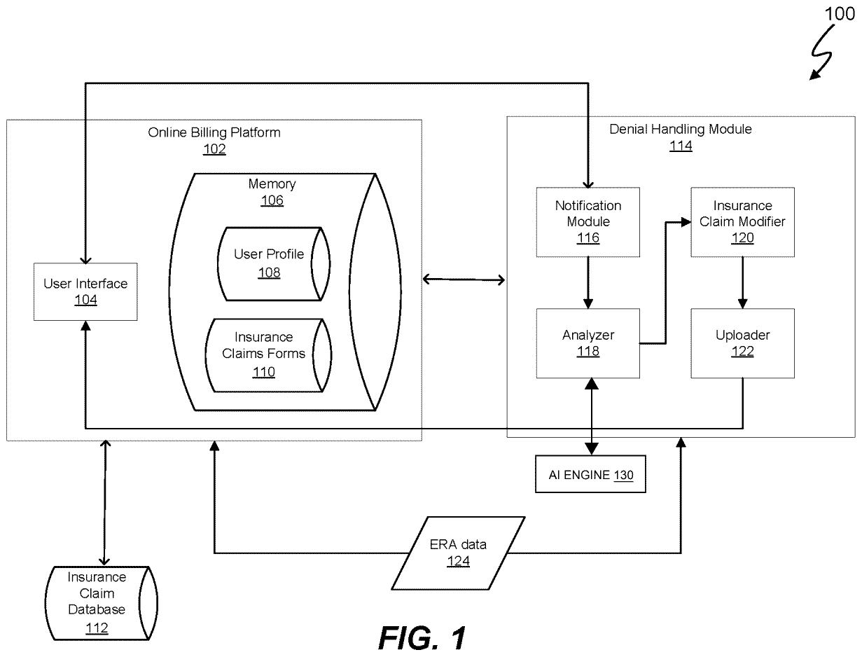

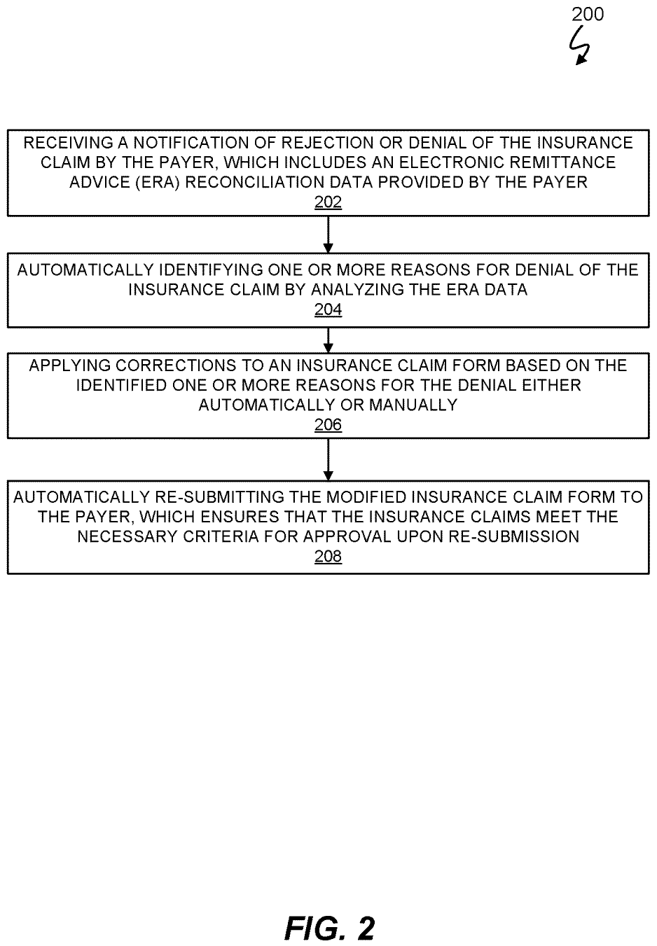

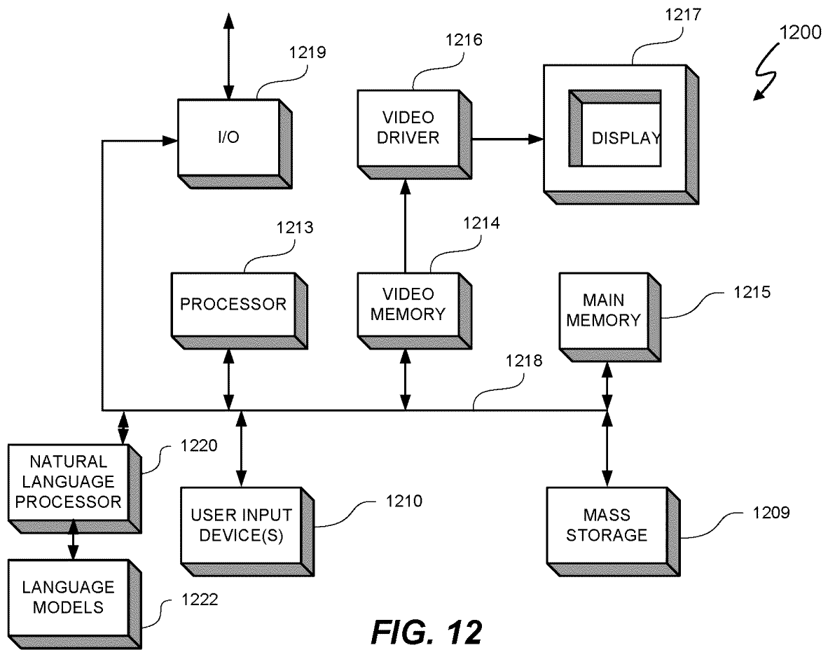

FIG. 1 depicts an exemplary automatic insurance claim denial management system 100 implemented on a computer system such as described below with reference to FIG. 12. FIG. 2 depicts an exemplary automatic insurance claim denial management process 200, utilized by the automatic insurance claim denial management system 100 implemented on the computer system.

Referring to FIGS. 1 and 2, in operation 202, a notification module 116 receives a notification of rejection or denial of the insurance claim by the payer. The notification also includes an Electronic Remittance Advice (ERA) reconciliation data 124 provided by the payer. The notification module 116 is integrated within a denial handling module 114. The denial handling module 114 is operatively coupled to an online billing platform 102, which can be used either by a user or any healthcare professional to submit pending insurance claims. The user may be either a patient or the parents, caregivers, or guardians of the patient. The healthcare professional may be any person who is allotted the responsibility to submit the insurance claims. The notification module 116 is configured to notify the healthcare providers and users about the presence of the denied insurance claims which includes the notifications for insurance claims requiring immediate attention or additional documentation. The notification module 116 also includes the ERA data along with the notification of the denied or rejected insurance claims.

Electronic Remittance Advice (ERA) data 124 is a digital document that provides detailed information about the payment or non-payment of medical insurance claims. The ERA data 124 is critical for processing insurance claims and maintaining payment structure between healthcare providers and insurance payers. ERA data 124 includes comprehensive details such as the amount paid for each claim, any adjustments made, and the reasons for these adjustments. This information helps healthcare providers understand the financial outcomes of the insurance claims submitted by them. Additionally, ERA data 124 includes patient and service details like medical session details, and so on, which are used to match the payment information with the corresponding insurance claims, ensuring accurate reconciliation. The ERA data 124 also provides payer identification and explanations for any claim denials or partial payments, allowing providers to address issues and make necessary corrections.

In operation 204, an analyzer 118 analyzes the ERA data 124 and automatically identifies one or more reasons for the denial of the insurance claim. The data collected is extracted from the notification module 116 and the ERA data 126 for analysis using the analyzer 118. Analyzer 118 is integrated into denial handling module 114. The analyzer 118 employs an artificial intelligence (AI) engine 130 to determine patterns in ERA data 124, enabling it to detect trends and anomalies that might indicate potential issues in future claim submissions and provide recommendations to correct existing claim submissions. By analyzing historical ERA data 124, the analyzer 118 can learn from historical claims and identify factors that commonly lead to denials or adjustments (collectively “denials”). This predictive capability helps healthcare providers correct existing denial problems, anticipate denial problems before they occur, improve the accuracy and efficiency of the claims process, and reduce the likelihood of future claim rejections or delays.

Following are exemplary prompts that guide and constrain the AI engine 130 to correct existing denial problems, anticipate denial problems before they occur, improve the accuracy and efficiency of the claims process, and reduce the likelihood of future claim rejections or delays. The prompts provide detailed role definition, context handling, and structured reasoning instructions so the AI engine 130 will consistently deliver actionable corrections to denied claims. The exemplary prompts include explicit placeholders for data fields the AI engine 130 uses to process and analyze the denial and generate a correction recommendation. Current Procedural Terminology (CPT)/Healthcare Common Procedure Coding System (HCPCS)/International Classification of Diseases, 10th Revision (ICD-10) are the three main medical coding systems used in the United States for billing, insurance claims, and healthcare documentation. The prompts also reference LCD/NCE which stand for Local Coverage Determination and National Coverage Determination. Although these codes are specifically referenced, other medical coding systems can be referenced in the prompt. Additionally, the below prompts are engineered for ChatGPT by OpenAI, LLC. In at least one embodiment, the analyzer 116 generates the prompts and populates the prompt with the data or links to the data indicated by the data placeholders.

### Prompt Title

### “Medical Claim Denial Review and Resubmission Expert”

### Prompt Text

### Role & Objective

You are an expert in medical billing, coding, and insurance claim denial management with deep knowledge of payer policies, CPT/HCPCS/ICD-10 coding, and claim adjudication rules.

Your task is to analyze a denied medical claim and determine how to correct and resubmit it to maximize the likelihood of approval.

Use the structured information provided below and follow the detailed analytical steps.

### Input Data (Populate All Placeholders)

### 1. Denial Report (Current Claim)

Denial Report ID: [Insert denial report ID]

Payer: [Insert payer name]

Date of Denial: [Insert date]

Claim ID: [Insert claim number]

Patient Name/ID: [Insert patient name or identifier]

Provider: [Insert provider name]

Denial Codes: [List denial codes, e.g., CO-97, PR-204]

Denial Reasons (from payer): [Copy exact reason text from denial report]

### Claim Service Lines

CPT/HCPCS Codes: [List all]
ICD-10 Diagnosis Codes: [List all]
Modifiers: [List modifiers used, if any]
Dates of Service: [List]
Billed Amounts: [List or total]

Supporting Documentation Submitted: [List or indicate “none”]

### 2. Historical Data (Prior Denials and Approvals)

Past Denials:
[Summarize prior claims with same denial codes, payers, or service types]

Corrected Resubmissions and Subsequent Approvals:
[List examples of corrected claims that were later approved, including what was changed]

Observed Correction Patterns:
[Describe recurring successful correction actions for similar denials]

### 3. Reference Information (If Available)

Payer Policy/LCD/NCD Reference: [Insert reference or “not provided”]

Prior Authorization Status: [Enter “approved,” “not obtained,” or “not required”]

Medical Necessity or Documentation Notes: [Enter any relevant information or “none”]

### AI Tasks

### Step 1: Interpret Denial Codes

Identify the meaning of each denial code in clear, understandable terms.
Include payer-specific context if available.

### Step 2: Review Historical Data

Compare the current denial against similar historical denials and resubmissions.
Summarize the corrective actions that led to successful approvals.

### Step 3: Analyze the Current Claim

Review the denied claim's coding, modifiers, diagnosis linkages, documentation, and payer requirements.
Identify probable causes of denial (missing modifier, incorrect diagnosis linkage, missing documentation, etc.).

### Step 4: Recommend Corrective Actions

Provide specific, actionable corrections for each issue identified.
Explain why each change should increase the likelihood of approval upon resubmission.
Reference applicable payer or CMS policy, CPT/ICD/NCCI edit rules, or documentation requirements.

### Step 5: Format Output As Follows

Denial Code: [Insert code and short description]

Root Cause: [Explain why the denial occurred]

Historical Pattern: [Describe similar denials and successful corrections]

Recommended Correction: [Provide precise, actionable steps to fix and resubmit]

Justification: [Explain why the correction aligns with policy or coding standards]

Estimated Approval Likelihood: [High/Medium/Low, with brief rationale]

Additional Notes: [List any missing or ambiguous information needed for confidence]

### Step 6: Ensure Compliance

Verify all recommendations conform to payer-specific rules, CMS guidance, CPT/HCPCS/ICD-10 coding, and NCCI edits.
Do not fabricate data; clearly indicate when additional information is required to make a recommendation.

### Example Output

Denial Code: CO-16—Claim/service lacks information needed for adjudication

Root Cause: Operative note missing for CPT 27447 (total knee arthroplasty)

Historical Pattern: Similar denials were overturned when operative notes and implant invoices were attached

Recommended Correction: Resubmit claim with operative note, implant invoice, and linked diagnosis M17.11

Justification: Payer policy SURG-202 requires operative documentation for arthroplasty claims

Estimated Approval Likelihood: High

Additional Notes: Verify the diagnosis linkage in Box 24E and ensure all pages of the op note are legible

Following is a JavaScript Object Notation (JSON)-structured version of the foregoing prompt optimized for medical insurance claim denial correction and resubmission guidance.

### Prompt Title:

### “Medical Claim Denial Review and Resubmission Expert”

### Prompt Text

### Role & Objective

You are an expert in medical billing, coding, and insurance denial management, trained in CPT, HCPCS, and ICD-10 coding, as well as payer-specific claim adjudication rules and CMS/NCCI compliance.

Your task is to analyze a denied medical claim and determine how to correct and resubmit it for the highest likelihood of approval.

### Input Data

Use the following labeled placeholders for structured data input:

### 1. Denial Report (Current Claim)

Denial Report ID: [Enter denial report ID]

Payer: [Enter payer name]

Date of Denial: [Enter date]

Claim ID: [Enter claim number]

Patient Name/ID: [Enter patient name or ID]

Provider: [Enter provider name]

Denial Codes: [List denial codes, e.g., CO-97, PR-204]

Denial Reasons (verbatim from payer): [Copy exact reason text]

Claim Service Lines:
CPT/HCPCS: [Enter codes]
ICD-10 Diagnosis Codes: [Enter codes]
Modifiers (if any): [Enter modifiers]
Billed Amounts: [Enter]
Dates of Service: [Enter]

Supporting Documentation Provided: [List or “none”]

### 2. Historical Data

Past Denials with Same Code(s):
[Summarize or list prior denial cases including denial codes, reasons, and claim types]

Corrected Resubmissions and Approvals:
[List or summarize the corrections that led to approval—e.g., “Added modifier 59”, “Linked diagnosis E11.9 to CPT 83036”, “Attached op report”]

Patterns Noted:
[Summarize any recurring successful correction patterns by denial code, payer, or CPT combination]

### 3. Reference Guidelines (If Available)

Payer Policy or LCD/NCD Reference: [Insert reference or “none provided”]

Prior Authorization/Medical Necessity Requirements: [Insert if known]

Documentation/Attachments Submitted Previously: [List or “none”]

### AI Tasks

### 1. Interpret Denial Codes

Decode each denial code and describe in plain language the reason for denial.
Include payer-specific interpretation if applicable.

### 2. Review Historical Data

Identify similar historical denial patterns.
Summarize what corrective actions previously led to successful approvals.

### 3. Analyze Current Claim

Compare the denied claim to past approved versions.
Identify coding errors, missing modifiers, diagnosis linkage issues, documentation deficiencies, or payer rule violations.

### 4. Recommend Corrective Actions

List specific and actionable corrections (e.g., modifier changes, documentation to attach, diagnosis code revisions).
Explain how each change aligns with payer policy, CPT/ICD-10 rules, or medical necessity standards.

### 5. Provide Structured Output

Format your response as follows:
Denial Code: [e.g., CO-97—Procedure or service not paid separately]
Root Cause: [Explanation]
Historical Pattern: [Summary of similar denials and successful corrections]
Recommended Correction: [Detailed correction instructions]
Justification: [Reference coding or payer rule supporting correction]
Estimated Approval Likelihood: [High/Medium/Low with brief rationale]
Additional Notes: [Any missing info needed for final determination]

### 6. Compliance Note

Ensure all recommendations comply with:
CMS guidelines and payer-specific edits
CPT, ICD-10, HCPCS, and NCCI standards
Documentation and medical necessity requirements

### Final Output Example

Denial Code: CO-16—Claim/service lacks information needed for adjudication
Root Cause: Missing operative note for procedure 27447 (total knee arthroplasty)
Historical Pattern: Similar claims approved after attaching op note and implant log
Recommended Correction: Resubmit claim with operative note and implant invoice attached
Justification: Payer requires documentation of implant type and surgical indication for coverage per policy SURG-202
Estimated Approval Likelihood: High
Additional Notes: Verify all diagnosis linkages match payer LCD L35081
Below is exemplary enhancement of the foregoing prompt with a section that allows automated “learning” for use by the bulk insurance claim re-submission module 112 to track correction outcomes and retrain the AI engine 130 on approval success patternsPrompt Title: “Self-learning/Adaptive Medical Claim Denial Review and Resubmission Expert”

### Prompt Text

### Role & Objective

You are an expert in medical billing, coding, and insurance denial management. You specialize in analyzing payer denials, identifying root causes, and determining corrective actions that maximize resubmission approval rates.

You operate as an adaptive learning assistant—improving over time by referencing prior denial outcomes and correction strategies.

### Input Data (Use Placeholders to Populate)

### 1. Denial Report (Current Claim)

Denial Report ID: [Insert denial report ID]

Payer: [Insert payer name]

Date of Denial: [Insert date]

Claim ID: [Insert claim number]

Patient Name/ID: [Insert patient name or ID]

Provider: [Insert provider name]

Denial Codes: [List denial codes, e.g., CO-97, PR-204]

Denial Reasons (verbatim): [Enter payer reason text]

Claim Service Lines:
CPT/HCPCS: [Enter codes]
ICD-10 Diagnosis Codes: [Enter codes]
Modifiers: [Enter modifiers if applicable]
Billed Amounts: [Enter]
Dates of Service: [Enter]

Supporting Documentation: [List or indicate “none”]

### 2. Historical Data

Past Denials:
[Summarize prior cases with same denial codes or similar scenarios]

Corrections That Led to Approval:
[Describe specific successful corrections, such as “Added modifier 59,” “Linked ICD-10 E11.9 to CPT 83036,” or “Attached operative report”]

Patterns Observed:
[List any recurring successful strategies by denial code, payer, or CPT combination]

### 3. Reference Policies & Requirements

Payer Policy Reference (if known): [Insert LCD/NCD or payer-specific policy number]

Medical Necessity Requirements: [Summarize or enter “none provided”]

Prior Authorization Info: [Insert or “not applicable”]

Documentation Requirements: [List required attachments if known]

### AI Tasks

### 1. Interpret Denial Codes

Decode each denial code and describe its meaning in simple, payer-relevant terms.
Include both general and payer-specific explanations if available.

### 2. Review Historical Data

Identify trends or patterns in previous denials with similar codes or claim types.
Summarize corrective actions that successfully resulted in approvals.

### 3. Analyze Current Claim

Compare denied claim data with historical success data.
Identify errors, omissions, or non-compliance in coding, modifier usage, diagnosis linkage, or documentation.

### 4. Recommend Corrective Actions

Provide specific, actionable steps to correct the claim.
Explain the rationale, referencing payer policy or coding standards (CPT, ICD-10, HCPCS, NCCI).
Suggest any supporting documentation or prior authorization evidence needed.

### 5. Generate Structured Output

Format your analysis as:
Denial Code: [e.g., CO-97—Procedure or service not paid separately]
Root Cause: [Why denied]
Historical Pattern: [Summary of similar denials and successful corrections]
Recommended Correction: [Detailed fix—e.g., “Add modifier 25 to 99213 for same-day procedure”]
Justification: [Why this change aligns with payer/coding rules]
Estimated Approval Likelihood: [High/Medium/Low with reasoning]
Additional Notes: [Any missing info or assumptions made]

### Compliance & Quality Check

Ensure recommendations comply with CMS, payer policies, and medical necessity rules.
Flag any ambiguous or missing data needed for confident resubmission.

### Learning & Feedback Integration

Purpose: Improve accuracy and efficiency over time by learning from actual resubmission outcomes.

When feedback data is available, use these placeholders:

Feedback Record Id: [insert Record Id]

Denial Code: [Insert]

Corrective Action Taken: [Describe what was done]

Outcome: [Approved/Denied Again]

Payer Comments (if available): [Insert]

Turnaround Time: [Insert days between submission and decision]

### Learning Tasks

1. Identify which corrective actions consistently lead to approvals for each denial code and payer.
2. Update internal reasoning patterns to prioritize those proven corrections in future recommendations.
3. If a previously successful correction failed this time, analyze potential differences (payer, claim context, service line).
4. Maintain a running table or mapping of:
   Denial Code→Most Effective Correction Type
   Payer→Policy Tendencies or Exceptions
   Approval Success Rate per Correction Strategy

### Output for Learning Summary

Denial Code: [e.g., CO-50]

Correction Strategies Tested: [List strategies]

Approval Success Rate: [e.g., 82%]

Most Effective Action: [e.g., Added missing documentation of medical necessity]

Observed Payer-Specific Nuances: [Describe]

Recommended Default Strategy for Future: [Summarize go-to correction]

Over time, the AI should refine its recommendations based on proven approval results, improving predictive accuracy and efficiency for denial management.

### Example Output

Denial Code: CO-16—Claim/service lacks information needed for adjudication

Root Cause: Missing operative report for CPT 27447 (total knee arthroplasty)

Historical Pattern: Past similar denials resolved by attaching op note and implant documentation

Recommended Correction: Resubmit claim with operative report and implant invoice attached

Justification: Payer policy SURG-202 requires operative documentation for all arthroplasty claims

Estimated Approval Likelihood: High

Additional Notes: Ensure diagnosis M17.11 is linked to CPT 27447 in Box 24E

The analyzer 118 helps in identifying the reasons of the denial or rejection of the insurance claims. The plurality of reasons for which one or more payers may reject or deny insurance claims incorporates various issues related to the accuracy and completeness of the submitted information. One common reason is the presence of inappropriate or insufficient information within the insurance claim form. This can include errors in patient details, such as incorrect identification numbers or misspelled names, and inaccuracies in the coding of medical procedures or diagnoses. Such discrepancies can prevent the insurance company from accurately processing the claim and matching it with the patient's insurance coverage. Another critical reason for claim denial is insurance expiration. If a claim is submitted after the patient's insurance policy has lapsed, the payer may reject the claim outright. This highlights the importance of verifying that the patient's insurance is active and valid at the time of service.

Additionally, claims may be denied if the requested reimbursement amount exceeds the threshold values established by the insurance policy. Insurance plans often have predefined limits for specific procedures or treatments, and claims exceeding these limits may not be fully covered. In such cases, the payer may only partially pay the claim or deny it altogether, depending on the policy terms. Non-covered medical sessions are another frequent cause of claim rejection. Insurance policies typically specify which treatments and services are covered, and any procedures outside this scope may not be reimbursable. General errors in the submission process also contribute to claim denials.

Finally, incomplete information from users whether healthcare providers or patients can lead to claim denials. This can occur if critical details such as patient demographics, treatment dates, or required documentation are missing or incomplete.

The analysis of the ERA data 124 involves several steps to accurately identify and address denial codes associated with rejected insurance claims. First, the analyzer 118 accesses and analyzes the ERA data 124 to automatically identify one or more denial codes. These denial codes are specific codes used by insurance companies or payers to explain why an insurance claim was rejected or denied. The identification process involves scanning the ERA data 124 for indicators or tags that correspond to common denial reasons, such as incorrect patient information, missing pre-authorization, or non-covered services. Once these denial reasons are identified, the next step takes place, which is accessing a denial code database.

In at least one embodiment, the ERA data 124 is stored in a memory, such as a denial code database. The denial code database is a comprehensive repository that contains a wide array of predefined codes, each corresponding to different denial reasons used by various insurance payers. This database is regularly updated to ensure it reflects current industry standards, payer-specific requirements, and regulatory changes. The analyzes 118 analyzes this database to find the correct denial code that matches the identified reason for rejection or denial of the insurance claim.

Finally, the analyzer 118 automatically maps the identified denial reason to its corresponding denial code by matching it with the appropriate code in the denial code database. This mapping process ensures that the denial reason identified during the ERA data 124 analysis is accurately categorized and associated with the correct denial code. By doing so, the denial handling module 114 facilitates efficient and precise insurance claim management, enabling healthcare providers to understand the exact reason for the insurance claim's rejection and take the necessary corrective actions. This automated process significantly reduces the risk of human error, speeds up the resolution of denied or rejected claims, and improves the overall efficiency of the claims management process.

In operation 206, an insurance claim modifier 120 applies corrections to an insurance claim form based on the identified one or more reasons for the denial of the insurance claims. The payment status of denied insurance claims is identified by categorizing the reasons why the particular insurance claims were either not paid or only partially paid by the insurance provider. For claims that were not paid, the reasons typically include inappropriate or insufficient information provided in the claim, such as missing or incorrect patient data, outdated insurance details, or incomplete documentation. Additionally, claims may be denied due to insurance expiration, meaning the policy was no longer active at the time of service. Other reasons include the amount billed exceeding the payer's threshold values for certain services, non-covered medical sessions that fall outside the scope of the policy, general errors in the claim submission, or incomplete information provided by the patient or healthcare provider. These factors lead to a complete denial of payment by the insurer.

On the other hand, partially paid insurance claims occur when the insurer agrees to cover some, but not all, of the services billed. Common reasons for partial payment include the inclusion of non-covered medical sessions, where the insurer only pays for services that are within the policy's coverage, and claims where the amount exceeds the threshold values set by the insurer for specific treatments or procedures. In these cases, the insurer pays up to the allowed limit, leaving the remaining balance unpaid.

These factors are analyzed by the analyzer 118 and provided to the insurance claim modifier 120. The insurance claim modifier 120 addresses and fixes these denied or rejected insurance claims, by doing the necessary modifications in the insurance claim form. These modifications include adding or updating documentation that supports the claim. This might involve attaching medical records, providing accurate patient information, or detailing the treatments administered, all of which are crucial for substantiating the claim. Another important modification is filling in any missing or incomplete information blocks that are required for accurate claim processing. This can include completing personal details, patient identification numbers, or insurance policy information that may have been omitted or incorrectly entered in the original submission. Additionally, correcting any errors or omissions found in the original claim is essential. This could involve rectifying incorrect patient data, such as name or date of birth, ensuring that service codes are accurate, or correcting billing errors. By making these modifications, the healthcare provider can resubmit the claim with the necessary information and documentation, increasing the likelihood of the claim being approved and paid by the payer.

In operation 208, an uploader 122 automatically re-submits the modified insurance claim form to the payer. The modified insurance claim form ensures that the insurance claims meet the necessary criteria for approval upon re-submission.

Finally, the denied or rejected insurance claims after being modified by the insurance claim modifier 120 are passed on to the uploader 124, which is also integrated within the denial handling module 114. The uploader 122 is further operatively coupled to user interface 104 of the online billing platform 102. The uploaded insurance claims that are modified by the automatic insurance claim denial management system 100 are visible to the user on the user interface 104 of the online billing platform 102.

The modified insurance claims are submitted to the insurance company or payer for the second time; hence they are known as secondary insurance claims. Some payers provide the freedom to the user to submit secondary claims, while some do not. This depends on the rules and policies of the insurance companies or payers. If the secondary insurance claim is further rejected or denied and is again modified and submitted to the payer, then it is known as a tertiary insurance claim.

The uploader 122 further generates a report summarizing the status of all insurance claims and provides a comprehensive overview of the healthcare provider's financial interactions with insurance payers. This report includes detailed categorizations of claims, such as those pending, rejected, or approved, offering insights into the current state of each claim. For pending or rejected claims, the report outlines the specific issues identified, such as missing information or documentation errors, and details the actions taken for reconciliation and re-submission. By highlighting the modifications made, such as correcting data inaccuracies or adding necessary documents, the report serves as a critical tool for tracking the progress of claims resolution and ensuring that all claims are accurately processed for timely reimbursement. The pending insurance claims along with the errors due to which they have been denied or rejected are made visible to the user on a user interface 104 integrated within the online billing platform 102.

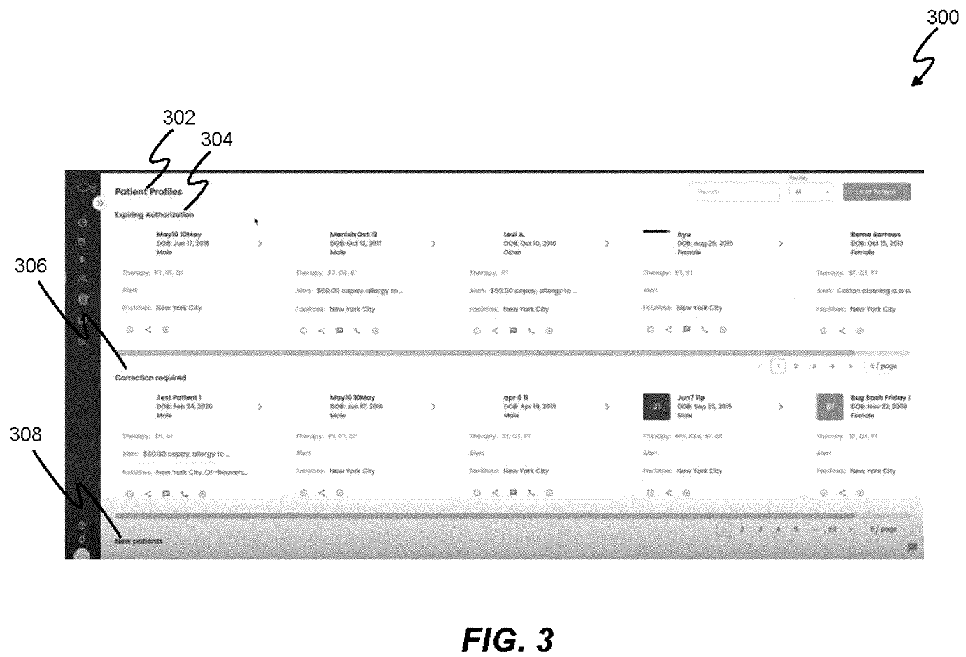

FIG. 3 depicts an exemplary user interface 300 disclosing the user profile categorized based on various parameters.

The user interface 300 shows the user profile, displaying the user details 108 and insurance claim details 110 of the user which are stored in the memory 106 of the online billing platform 102. The patient profile 302 includes a plurality of user profiles each categorized into different categories and placed under the respective categories. These categories include: ‘Expiring Authorization’ 304, ‘Correction Required’ 306, ‘New Patients’ 308, and so on.

The ‘Expiring Authorization’ 304 profile includes details of all those users whose insurance authorization is about to expire. The expiring authorization refers to a situation where a prior authorization, granted by an insurance company for a specific medical service or procedure, is nearing its expiration date. Prior authorization is a requirement from the insurance company that the healthcare provider obtains approval before providing certain services to ensure that they are covered under the patient's insurance plan. This authorization typically has a validity period, during which the approved services must be reduced. The automatic insurance claim denial management system 100 detects the profile of those users which is about to expire using machine learning techniques and informs them in advance in order to reduce the chances of insurance claim rejection or denial.

If the services are not provided within this authorized time frame, or if the authorization expires before the services are completed, the insurance company may deny payment for those services. In such cases, the healthcare provider may need to request a renewal or extension of the authorization to ensure that the services are covered and the claim is not denied due to an expired authorization. Managing expiring authorizations is crucial for healthcare providers to secure reimbursement for the services they provide.

The ‘Correction Required’ 306 includes the details of profiles of all those users whose insurance claims are rejected or denied by the payer. The rejection or denial of the insurance claim may be due to any of the reasons like inappropriate or insufficient information (i.e. inaccurate information), the amount exceeding the threshold values, non-covered medical sessions, general errors, and incomplete information from users. The ‘New Patients’308 includes the details of all the new users registered to the medical center.

The categories ‘Expiring Authorization’ 304, ‘Correction Required’ 306, and ‘New Patients’ 308 include user details 108 like name, DOB of the user, and therapy center address of the user, and insurance claims details 110 like any substance or medicine allergic to the user, the amount to be paid by the user i.e., copay. The copay (copayment) is a fixed amount that a patient is required to pay out-of-pocket for a specific healthcare service or prescription medication at the time the service is provided. The copay is a form of cost-sharing between the insurance company and the patient, where the patient pays a portion of the cost, and the insurance company covers the rest.

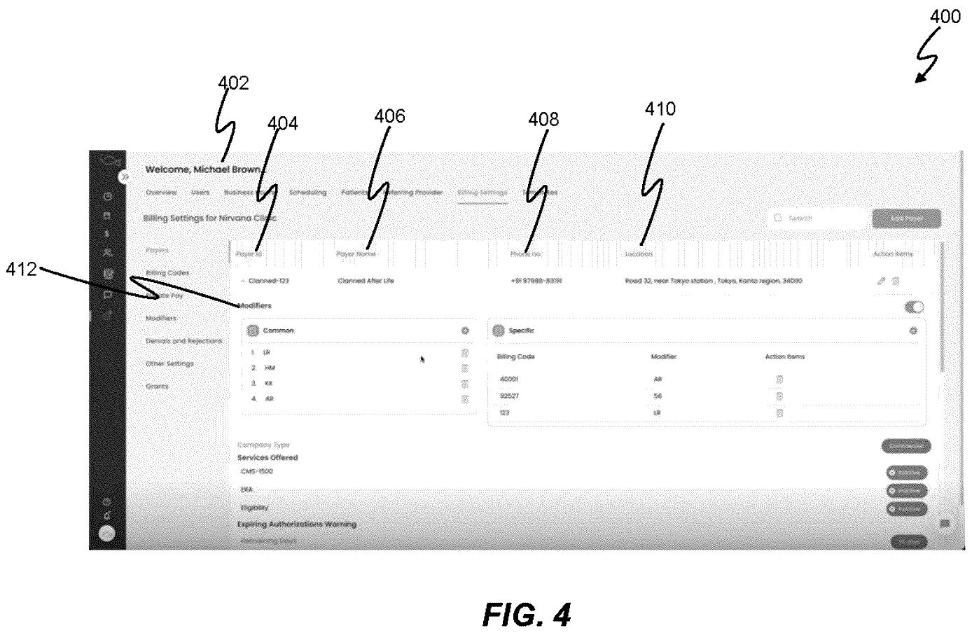

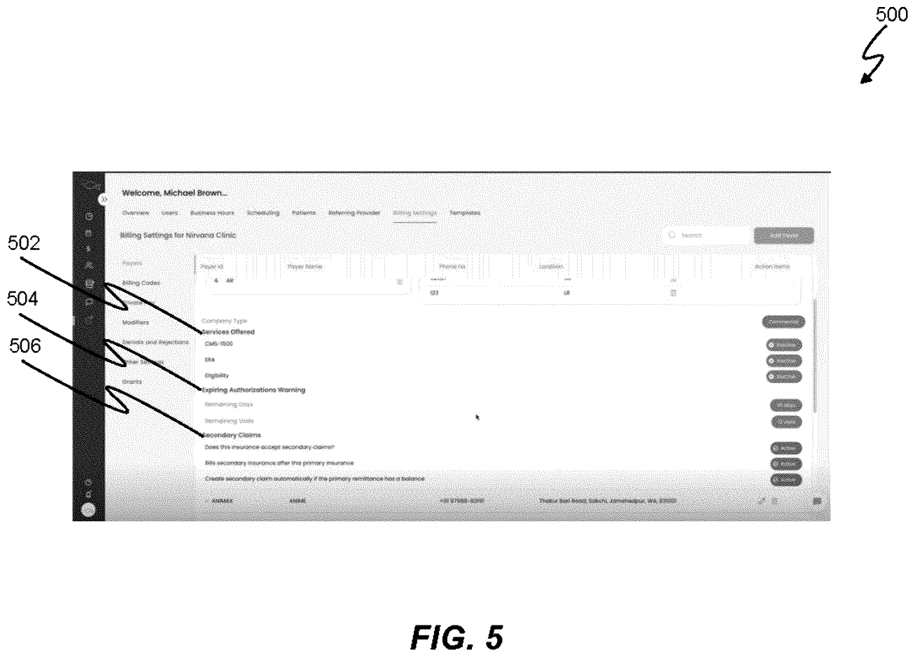

FIGS. 4 and 5 depict exemplary user interfaces disclosing the billing details and other categories which are detected automatically by the automatic insurance claim denial management system 100 to reduce the denial or rejection of the insurance claim.

The user interface 400 depicts the billing details of the user. The ‘user name’ 402 is shown at the top left corner of the user interface 400. The details of the payer, including, ‘Payer ID’ 404, ‘Payer Name’ 406, ‘Phone No.’ 408, and ‘Location’ 410 are also provided in the user interface 400. A unique ‘Payer ID’ 404 is allotted to each payer so that the chances of confusion are less.

The details of different ‘Modifiers’ 412 are also provided and shared with the payer in the insurance claim form. Every modifier has its meaning, if a wrong modifier is entered in the insurance claim form, then the insurance claim may get rejected or denied, based on the circumstances. Modifiers are two-character alphanumeric codes used in medical billing and coding to provide more information about procedures and services. They can be used to indicate that a procedure or service has been changed by a specific circumstance, but not changed in its code or definition. Modifiers can also be used to improve the accuracy of claims, obtain proper reimbursements, and avoid claim denials.

The modifiers are defined by the government organizations and are followed by each payer or insurance company. The modifiers also help in determining the total cost of the therapy. For instance, if a junior doctor or an assistant provides therapy to a child, then the automatic insurance claim denial management system 100 will add the modifier as ‘HM’, which is used when the therapy is conducted by the assistant or some junior therapists. This will automatically reduce the overall cost, as the cost of therapy by the assistant or junior will be less. Similarly, if a certified senior doctor provides therapy to a child, then the automatic insurance claim denial management system 100 will add the modifier as ‘CO’, which is used when the therapy is conducted by the certified therapist. This will increase the cost of the overall therapy.

Further, in the user interface 500 provides the details about ‘Services Offered’ 502, ‘Expiring Authorization Warning’ 504, and ‘Secondary Claims’ 506.

The ‘Services Offered’ 502

The ‘Expiring Authorization Warning’ 504 includes details like the remaining days of the insurance and the remaining visits that the insurance will cover. For example, in the case of the present scenario, there are only 35 days left in the insurance of the user and it will cover only 12 more visits. All this information is made visible to the user on the online billing platform 102 in advance so that the user can renew their insurance as soon as possible in order to avoid any problems during the billing.

The ‘Secondary Claims’ 506 includes details like ‘Does the insurance accept secondary claims?’, ‘Bills secondary insurance after the primary insurance?’, ‘Create a secondary claim automatically if the primary remittance has a balance?’, and so on. In the case of the present example, all three are marked as ‘Active’, which means the payer allows secondary claims and makes payment to them as well. Further, these claims are automatically generated by the automatic insurance claim denial management system 100, once the primary insurance claim is rejected or denied and has some pending amount.

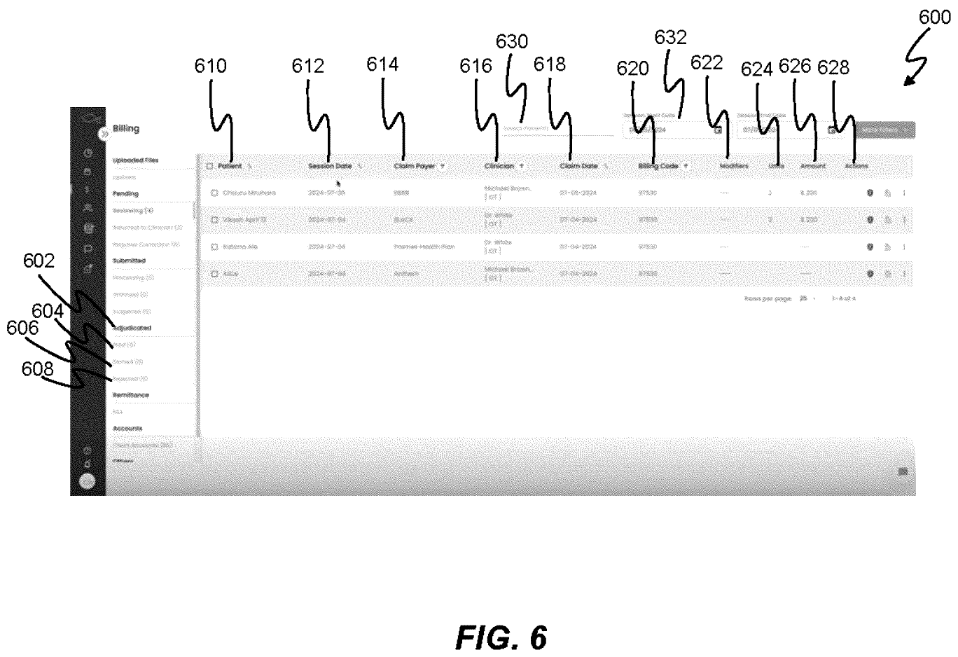

FIG. 6 depicts an exemplary user interface 600 disclosing the list of denied or rejected insurance claims received from one or more payers.

The user interface 600 discloses the list of all the users whose insurance claims are either rejected or denied by the insurance company i.e., the payer. The details of the insurance claims that are paid by the payer are also displayed on the user interface 600. The user interface 600 includes a tab ‘Adjudicated’ 602 which has three different sub-sections namely, ‘Paid’ 604, ‘Denied’ 606, and ‘Rejected’ 608.

Upon clicking on the tab ‘Paid’ 604, the list of all the insurance claims that are paid by the payer is displayed on the user interface 600 of the online billing platform 102.

Upon clicking on the tab ‘Denied’ 606, the list of all the users whose insurance claims are denied by the payer is displayed here. The denials occur after the insurance company has received and fully processed the claim. The denied insurance claim means that the insurance company has evaluated the claim and decided not to authorize payment based on the terms of the insurance policy. Denial reasons often include situations where the claim involves pre-existing medical conditions that are not covered, services that are specifically excluded by the policy, or claims that are submitted after the policy's deadline for filing. Addressing a denial typically involves appealing the insurer's decision. This appeal process may require providing additional documentation or clarifying the circumstances with the payers. Denials often require more time and effort to resolve compared to rejections, as they involve challenging the insurer's assessment rather than simply correcting form errors.

Upon clicking on the tab ‘Rejected’ 608, the list of all the users whose insurance claims are denied by the payer is displayed here. The list contains details such as user name 610, date of session 612, claim payer 614, clinician 616, claim date 618, billing code 620, modifiers 622, units 624, amount 626, and actions 628.

The users name 610 includes the name of the user, and the date of session 612 includes the date on which the medical session is held. The claim payer 614 includes the details of the payer i.e., the insurance company who is making the payment, the clinician 616 includes details of the therapist or the medical expert who is taking medical sessions, and the name of the medical sessions. The claim date 618 includes the date on which the insurance claim is sent to the payer for the first time, and the billing code 620 includes the identification code for that insurance claim. Further, the modifier 622 are alpha-numeric codes that provide extra details about the medical session, the units 624 discloses the duration of a medical session, for instance, 15 minutes is equal to 1 unit. The amount 626 depicts the actual charge for that particular medical session, and the actions 628 discloses alert messages, and various other options like refresh, modify, share, and so on.

Rejections happen before the insurance company officially receives and processes the claim. A claim is rejected because it is incomplete or incorrect, making it non-processable in its current form. Common reasons for rejections include missing, incorrect, outdated, or partial information on the claim form. For example, if key details like patient information, service dates, or billing codes are incorrect or omitted, the claim cannot be processed. Other causes for rejections might include a lapsed insurance policy, billing errors, or attempts to bill for services not covered by the insurance policy. To resolve a rejected claim, the submitter must correct the errors or omissions and resubmit the insurance claim with the proper information and documents.

The list can be accessed either by directly entering the user's name in the tab ‘user name’ 630, or using filters like ‘session start date’ and ‘session end date’ 632. Other filters like therapist name, therapy-based, and so on can be used to access the list.

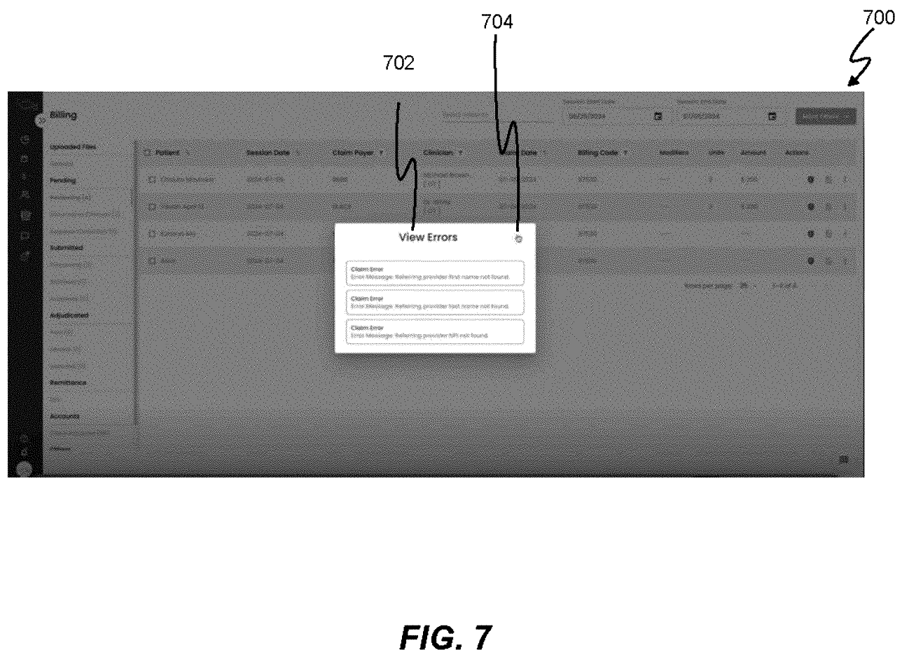

FIG. 7 depicts an exemplary user interface 700 that discloses the reason for the rejection or denial of the insurance claim from the payer.

The user interface 700 discloses the reason for the rejection or denial of the insurance claim. The reason for the rejection or denial of the insurance claim is automatically detected using the insights provided by the analyzer 118. The analyzer 116 provides insights after analyzing the ERA data 124 and the user detail 108 and insurance claim details 110 stored in the memory 106 of the online billing platform 102.

ERA data 124 provides a detailed record of how submitted insurance claims are processed by payers, including payment adjustments, denials, and the reasons behind them. The analyzer 118 analyzes this data to identify discrepancies between the expected and actual outcomes of claims. For instance, discrepancies may arise from incorrect billing codes, mismatched patient information, missing documentation, or details that do not align with the coverage terms of the insurance policy. The automated analysis highlights these issues, such as claims submitted with outdated patient information or insufficient justification for the medical services provided, which can result in partial payments or denials. By flagging these errors 702 and discrepancies, the healthcare providers and users are notified of the specific areas needing correction, enabling timely and accurate modifications. This process ensures that resubmitted claims are complete and accurate, reducing the likelihood of further delays or denials, and facilitating quicker reimbursements.

The error 702 is shown with a red flag 704. Upon clicking on that red flag 704, the errors on that particular insurance claim are displayed to the user using the online billing platform 102 on the user interface 700.

The errors 702 generated may be like, for instance, ‘Referring provider first name not found’, ‘Referring provider last name not found, ‘Referring provider NPI not found’, and so on. The user using the online billing platform 102 looks after these errors 702 and either modifies them manually or automatically using the insurance claim modifier 120, whichever is needed in that situation.

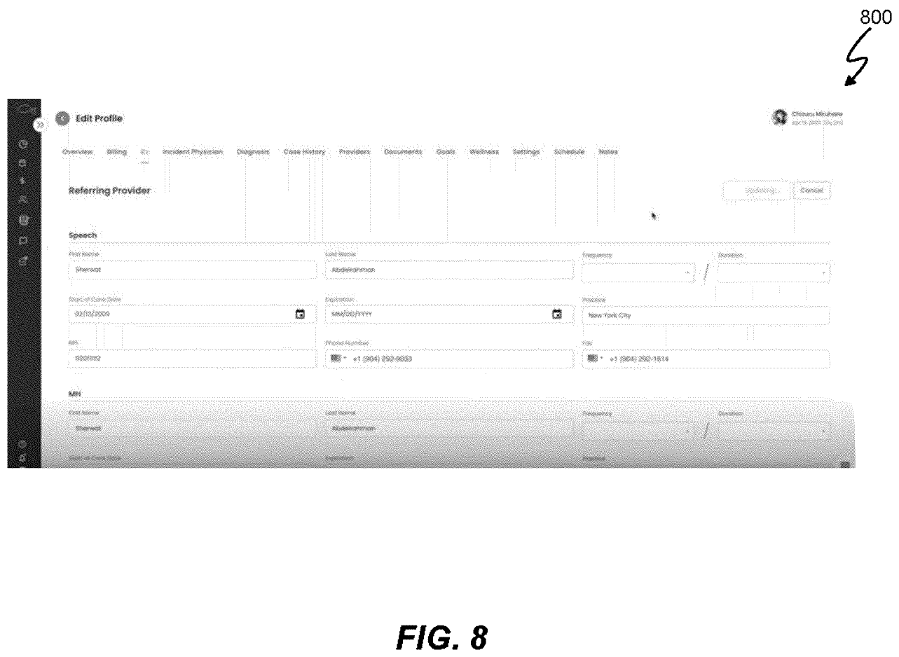

FIG. 8 depicts an exemplary user interface 800 that discloses the insurance claim form that is modified by the automatic insurance claim denial management system 100.

The user interface 800 discloses the modified insurance claim form based on error 702 displayed to the user using the online billing platform 102 on the user interface 700. The changes can be made either manually, or it can be done automatically using the insurance claim modifier 120.

The insurance claim modifier 120 addresses and corrects issues that cause insurance claims to be pending or denied. For instance, the insurance claim modifier 120 may add or update the necessary documentation that supports the pending claim. This may include medical records, detailed patient information, or comprehensive treatment details that provide a clear and complete picture of the services rendered. Accurate and thorough documentation is essential for validating the claim and ensuring that it meets the payer's requirements.

Further, the insurance claim modifier 120 may also be used to fill in any missing or incomplete information blocks crucial for the accurate processing of the claim. This step involves providing or correcting personal details, patient identification, or insurance information that may have been missing or incorrectly entered in the original submission. Accurate data entry is vital to prevent confusion or errors that could lead to claim denials.

Also, the insurance claim modifier 120 may fill in any errors or omissions found in the initial claim submission. This includes correcting inaccuracies in patient data, such as names, dates of birth, or insurance policy numbers, as well as rectifying any coding errors related to the medical procedures or diagnoses. By ensuring all information is accurate and complete, the insurance claim modifier 120 helps in reducing the likelihood of further delays or denials and facilitating quicker and more accurate reimbursement for healthcare providers.

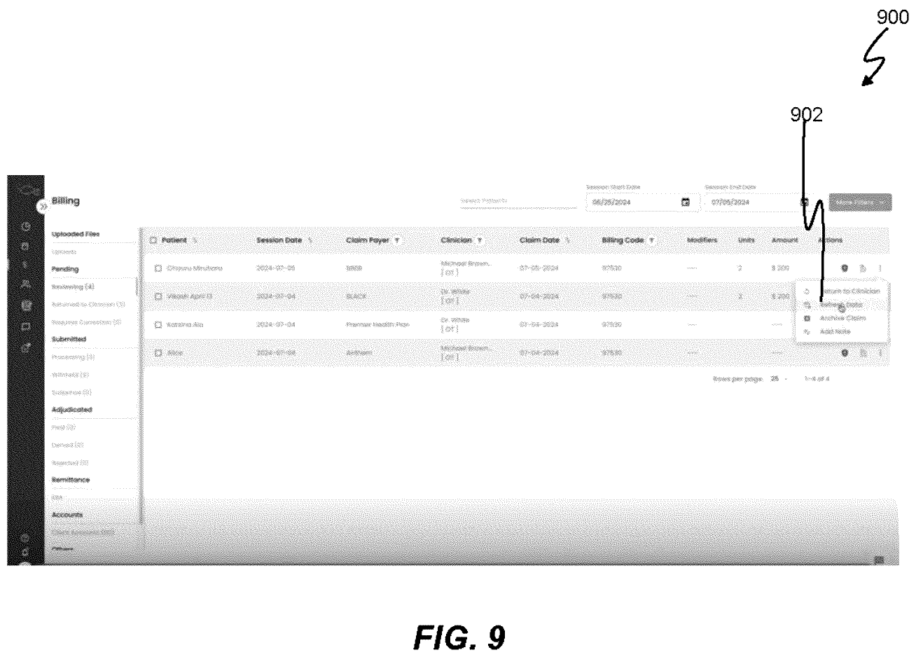

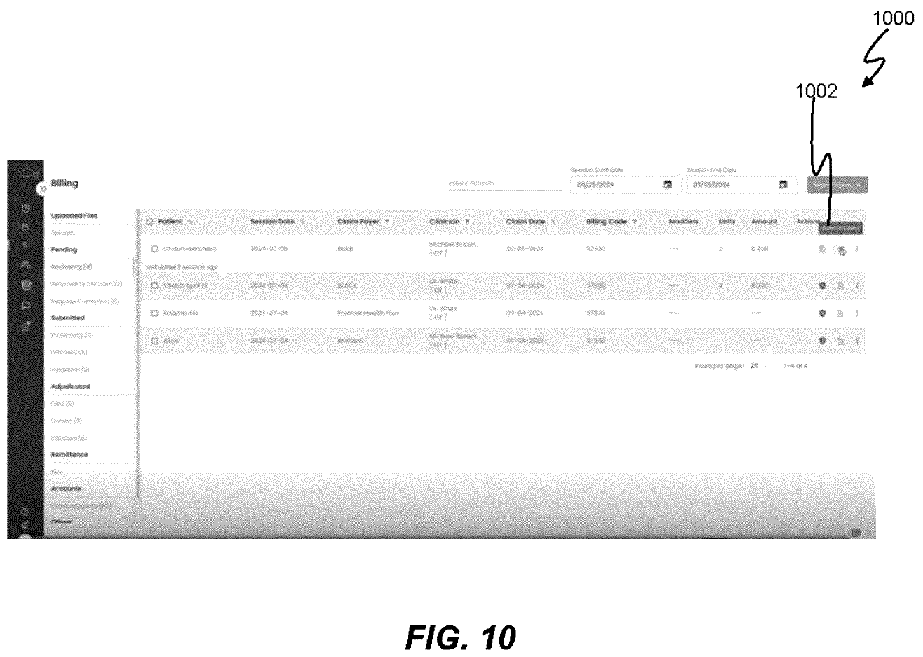

FIGS. 9 and 10 depict exemplary user interfaces that refresh the rejected or denied insurance claim form after modification and submit it to the payer respectively.

Upon modification of the insurance claim form using the insurance claim modifier 120, the list of rejected or denied insurance claims displayed on the user interface 600 is refreshed by clicking on the tab ‘Refresh’ 902. By clicking on the tab ‘Refresh’ 902, the denied or rejected insurance claims get updated and ready for submission.

Finally, in user interface 1000, the user can click on the ‘Submit’ tab 1002 to submit the modified insurance claim form to get the reimbursement done by the payer. The modified insurance claim form that is submitted again to the payer is known as the secondary insurance claim form. Further, if any errors are detected in the insurance claim form, then again, an updated version of the insurance claim form is sent to the payer, known as a tertiary insurance claim form.

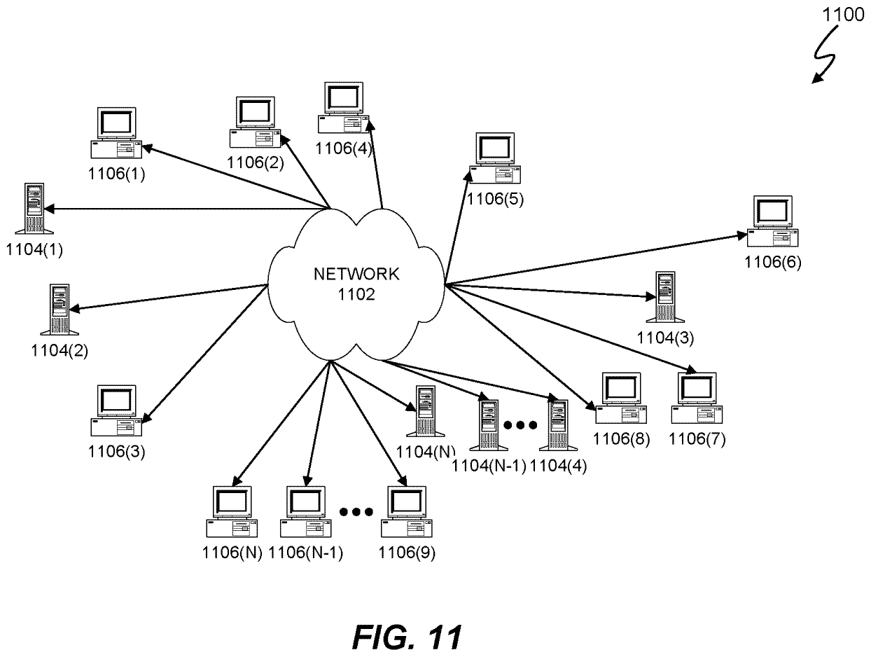

FIG. 11 is a block diagram illustrating a network environment in which an automatic insurance claim denial management system 100 and process 200 may be practiced. Network 1102 (e.g. a private wide area network (WAN) or the Internet) includes several networked server computer systems 1104(1)-(N) that are accessible by client computer systems 1106(1)-(N), where N is the number of server computer systems connected to the network. Communication between client computer systems 1106(1)-(N) and server computer systems 1104(1)-(N) typically occurs over a network, such as a public switched telephone network over asynchronous digital subscriber line (ADSL) telephone lines or high-bandwidth trunks, for example, communications channels providing T1 or OC3 service. Client computer systems 1106(1)-(N) typically access server computer systems 1104(1)-(N) through a service provider, such as an internet service provider (“ISP”) by executing application-specific software, commonly referred to as a browser, on one of client computer systems 1106(1)-(N).

Client computer systems 1106(1)-(N) and server computer systems 1104(1)-(N) are specialized computers programmed to improve conventional computer systems to implement and utilize the automatic insurance claim denial management system 100 and process 200. The type of computer system that can be specially programmed to implement and utilize the automatic insurance claim denial management system 100 and process 200 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the automatic insurance claim denial management system 100 and process 200 can be implemented using code stored in a tangible, non-transient computer-readable medium and executed by one or more processors. In at least one embodiment, the automatic insurance claim denial management system 100 and process 200 can be implemented completely in hardware using, for example, logic circuits and other circuits including field programmable gate arrays.

Embodiments of the automatic insurance claim denial management system 100 and process 200 can be implemented on a computer system such as a special-purpose, special-programmed computer 1200 illustrated in FIG. 12. Input user device(s) 1210, such as a keyboard and/or mouse, are coupled to a bi-directional system bus 1218. The input user device(s) 1210 are for introducing user input to the computer system and communicating that user input to processor 1213. The computer system of FIG. 12 generally also includes a non-transitory video memory 1214, non-transitory main memory 1215, and non-transitory mass storage 1209, all coupled to bi-directional system bus 1218 along with input user device(s) 1210 and processor 1213. The mass storage 1209 may include fixed and removable media, such as a hard drive, one or more CDs or DVDs, solid state memory including flash memory, and other available mass storage technology. Bus 1218 may contain, for example, 32 of 64 address lines for addressing video memory 1214 or main memory 1215. The system bus 1218 also includes, for example, an n-bit data bus for transferring DATA between and among the components, such as CPU 1209, main memory 1215, video memory 1214, and mass storage 1209, where “n” is, for example, 32 or 64. Alternatively, multiplex data/address lines may be used instead of separate data and address lines.

I/O device(s) 1219 may provide connections to peripheral devices, such as a printer, and may also provide a direct connection to a remote server computer system via a telephone link or to the Internet via an ISP. I/O device(s) 1219 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1209, into main memory 1215 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1213, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1215 consists of dynamic random-access memory (DRAM). Video memory 1214 is a dual-ported video random access memory. One port of the video memory 1214 is coupled to the video amplifier 1216. The video amplifier 1216 is used to drive the display 1217. Video amplifier 1216 is well-known in the art and may be implemented by any suitable means. This circuitry converts pixel DATA stored in video memory 1214 to a raster signal suitable for use by display 1217. Display 1217 is a type of monitor suitable for displaying graphic images.

The computer system described above is for purposes of example only. The automatic insurance claim denial management system 100 and process 200 may be implemented in any type of computer system programming or processing environment. It is contemplated that the automatic insurance claim denial management system 100 and process 200 might be run on a stand-alone computer system, such as the one described above. The automatic insurance claim denial management system 100 and process 200 might also be run from a server computer systems system that can be accessed by a plurality of client computer systems interconnected over an intranet network. Finally, the automatic insurance claims denial management system 100 and process 200 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of automatically managing denied insurance claims from at least one payers, the method comprises:
executing code using at least one processors of a computer system to cause the computer system to perform operations comprising:
receiving a notification of denial of an insurance claim by the payer responsive to a previously submitted insurance claim form, wherein the notification includes an Electronic Remittance Advice (ERA) reconciliation data provided by the payer;
automatically analyzing the ERA data to identify at least one reason for denial of the insurance claim, wherein automatically analyzing the ERA data comprises:
accessing the ERA data from a memory;
accessing insurance claim denial codes in a repository of denial codes; and
mapping the identified denial reason to a corresponding denial code by matching the denial reason to the corresponding denial code;
prompting an artificial intelligence engine to determine an insurance claim correction recommendation, wherein the prompt is guided with denial code data and historical successful rejected claim submission data;
automatically applying corrections to the previously submitted insurance claim form based on the identified at least one denial reason; and
automatically re-submitting the corrected insurance claim form to the payer for approval by the payer.

2. The method of claim 1 wherein the at least one reasons for denial of the insurance claim includes inaccurate information, insurance expiration, the amount exceeding the threshold values, non-covered medical sessions, general errors, and incomplete information from users.

3. The method of claim 1 wherein the ERAs provide detailed information about the payment, including an amount paid, any adjustments made, and the reason codes.

4. The method of claim 1 wherein identifying a payment status from the reasons of the denied insurance claims further comprises:
not paid due to inaccurate information, insurance expiration, the amount exceeding the threshold values, non-covered medical sessions, general errors, and incomplete information from users; and
partially paid insurance claims due to non-covered medical sessions, and the amount exceeding the threshold values.

5. The method of claim 1 wherein the modified claim form acts as a secondary medical insurance claim sent to the payer.

6. The method of claim 1, wherein the errors and discrepancies that cause the insurance claim to be rejected and require modifications are automatically detected and flagged based on the analyzed ERA reconciliation data.

7. The method of claim 1 wherein the modifications needed for fixing the denied or rejected insurance claims include:
adding or updating documentation that supports the pending insurance claim, such as medical records, patient information, and treatment details;
filling in any missing or incomplete information blocks that are required for accurate insurance claim processing, such as personal details, patient identification, and insurance details; and
correcting any errors and omissions found in the original insurance claim submission, such as incorrect patient data.

8. The method of claim 1 wherein the payer is an insurance company, provided with a unique ID code.

9. A system for automatically managing denied insurance claims from one or more payers comprises:
one or more processors of a computer system; and
a memory, coupled to the one or more processors, that stores code and execution of the code by the one or more processors causes the computer system to perform operations comprising:
receiving a notification of denial of an insurance claim by the payer responsive to a previously submitted insurance claim form, wherein the notification includes an Electronic Remittance Advice (ERA) reconciliation data provided by the payer;
automatically analyzing the ERA data to identify at least one reason for denial of the insurance claim, wherein automatically analyzing the ERA data comprises:
accessing the ERA data from a memory;
accessing insurance claim denial codes in a repository of denial codes; and
mapping the identified denial reason to a corresponding denial code by matching the denial reason to the corresponding denial code;
prompting an artificial intelligence engine to determine an insurance claim correction recommendation, wherein the prompt is guided with denial code data and historical successful rejected claim submission data;
automatically applying corrections to the previously submitted insurance claim form based on the identified at least one denial reason; and
automatically re-submitting the corrected insurance claim form to the payer for approval by the payer.

10. The system of claim 10 wherein the denied insurance claims are visible to the user or healthcare provider on a user interface integrated within the online billing platform.

11. The system of claim 10 wherein the one or more databases store historical claim data, patient records, and documentation necessary for verifying and supporting insurance claims when denied or rejected by the payer.

12. The system of claim 10 wherein the analyzer utilizes machine learning algorithms to identify patterns in the denial reasons to predict potential issues in future insurance claim submissions for each user.

13. The system of claim 10 wherein the notification module notifies healthcare providers and users about the presence of the denied or rejected insurance claims, including notifications for insurance claims requiring immediate attention or additional documentation.
